(19) United States
(12) Patent Application Publication
(10) Pub. No.: US 2015/0135565 A1
(43) Pub. Date: May 21, 2015

(54) MODEL CARD

(71) Applicant: Lunar Lime Limited, Gatwick, Sussex (GB)

(72) Inventor: Jonathan Klemenz, Sussex (GB)

(21) Appl. No.: 14/403,719

(22) PCT Filed: May 21, 2013
(86) PCT No.: PCT/GB2013/051318

§ 371 Date: Nov. 25, 2014

(30) Foreign Application Priority Data
May 25, 2012 (GB) 1209176.5

(51) Int. Cl. B42D 15/04

(52) U.S. Cl. CPC B42D 15/042; A63H 33/16
USPC 40/124.08; 446/147

(57) ABSTRACT

A flexible sheet (1) comprising at least one removable blank (5) wherein the blank (5) is configured to be foldable into a three-dimensional model (13).

The present invention relates to a collectible card.

Collectible card games and collectible stickers are very popular with young children. For example, collection of “Moshi Monster®” and “Pokemon®” stickers and trading cards is well-known. Such games often require the user to swap cards to complete a collection; or achieve a more-valued collection because each different card has a different status. Children can collect the cards, but it has been found that the level of educational benefit and interaction with such cards is fairly limited.

The art of origami involves folding paper into models. Origami kits provide sheets of paper and directions whereby a user can form a model, for example of a well-known building such as the Empire State Building or the White House. Such kits can be bought as ready-made packages or can be downloaded from the internet, printed and cut-out. Such complex modelling kits require a user to fold and combine multiple sheets of paper, which need to then be glued together. The intricacy of origami modelling is often too complicated for use by children and the resulting three-dimensional models are often too delicate to be played with by a child for any length of time.

The present invention sets out to alleviate the problems described above by providing a card which provides educational benefit to children, and a foldable model that is both simple to make and secure in its construction.

In one aspect, the invention provides a flexible sheet comprising at least one removable blank wherein the blank is configured to be foldable into a three-dimensional model.

A collectible card incorporating a foldable model provides an attractive incentive for a child to learn how to fold and form the model. This provides educational benefit and allows a toy to be made that is safe to play with and interesting to collect.

Preferably, the removable blank is a single-piece.

A single-piece removable blank is easy to remove from the flexible sheet in which is contained and is safe and convenient for a child to fold.

Preferably, the or each removable blank comprises a plurality of fold lines.

Optionally, the fold lines comprise lines of perforations in the removable blank.

More preferably, the plurality of fold lines are marked onto the surface of the blank.

By clearly marking the fold lines a child can easily follow folding instructions to accurately construct the three-dimensional model.

Preferably, the flexible sheet is substantially rectangular.

More preferably, the flexible sheet has a width of about 105 mm and a height of 148.5 mm.

Within this specification, the term “about” is interpreted to mean optionally ±20%, preferably optionally ±10%, more preferably optionally ±5%.

It has been found that a size approximately that of the standard “A6” paper size is small enough for the cards to be conveniently carried whilst providing a secure frame to hold the foldable blank.

Preferably, the flexible sheet has a paper density of about 200 to 400 g/m², preferably about 200 to 300 g/m².

More preferably, the flexible sheet has a paper density of about 280 g/m².

The desired density of paper allows the card to be flexed for removal of the blank and for folding of the blank into a three-dimensional model, whilst also ensuring that the card is strong enough to support the removable blank and the folded three-dimensional model is stable enough to be played with.

Preferably, the flexible sheet comprises printed matter on at least one surface.

More preferably, the flexible sheet comprises printed matter on both planer surfaces.

Optionally, the flexible sheet comprises a laminate material or a foil material.

A laminate or a foil material allows the flexible sheet to resist tearing.

More preferably, the flexible sheet is pre-printed by lithographic or digital printing.

A printed surface allows the flexible sheet to display folding instructions to illustrate to a user how to fold the removable blank into a three-dimensional model. Furthermore, the printed matter can be used to display other graphics to decorate the sheet. For example, the printed matter includes features of the model, such as eyes, mouth or other details and/or details depicting the value of the model/card for collecting the cards or playing a game.

Preferably, the removable blank is configured to be foldable into a self-standing three-dimensional model.

Optionally, the three-dimensional model comprises at least one leg to support the model on a substantially flat surface.

Preferably, the removable blank comprises at least one tab and a least one slot, wherein the tab is slideable through the slot to be secured therethrough.

The tab/slot arrangement of the present invention makes it easy to form a secure three-dimensional model from the foldable blank, such that the three-dimensional model can be held in place and played with, without the use of adhesive.

Preferably, the or each slot is curved.

More preferably, the or each tab comprises at least one curved surface.

A curved tab allows the tab to be easily fed through a slot without the surface of the tab catching on the slot. Furthermore, a curved surface allows the tab to be fed through a slot without requiring precise alignment of the tab with the slot into which it is received. This ensures that the model is suitable to be created by small children.

Preferably, the tab comprises at least one straight side protruding at an angle of about forty-five degrees to the perimeter of the blank.

An acute angle between the tab and the blank provides a notch to lock in position after the tab has been fed through a slot.

Preferably, the or each tab comprises a curved side and a straight side wherein the straight side is at an angle of about forty-five degrees to the perimeter of the blank.

Preferably, the length of the tab is between about 8 and 12 mm.

Preferably, the length of the slot is between about 8 and 13 mm.

More preferably, the slot is about 1 mm longer than the length of the tab.

By providing a slightly longer slot, the tab can easily be inserted in a direction perpendicular to the length of the slot and can then slide along the slot in a direction parallel to the length of the slot to secure/lock the tab and slot together.

Preferably, the flexible sheet and/or blank comprises recognition elements for activating application software.

Preferably, the application software comprises augmented reality.

Preferably, the flexible sheet and/or blank comprises recognition elements for augmented reality software.

According to another aspect of the present invention, there is provided application software for use with a flexible sheet and/or blank as described herein.

According to another aspect of the present invention, there is provided augmented reality software for use with a flexible sheet and/or blank as described herein.

In another aspect of the present invention, there is provided a system for the software described herein. Preferably, the system comprises computer hardware, for example in the form of a hand-held device.

Preferably, the computer hardware comprises one or more data processing means and/or one or more storage means and/or one or more user interaction means.

The invention will now be described by way of example with reference to the accompanying diagrammatic drawings, in which:

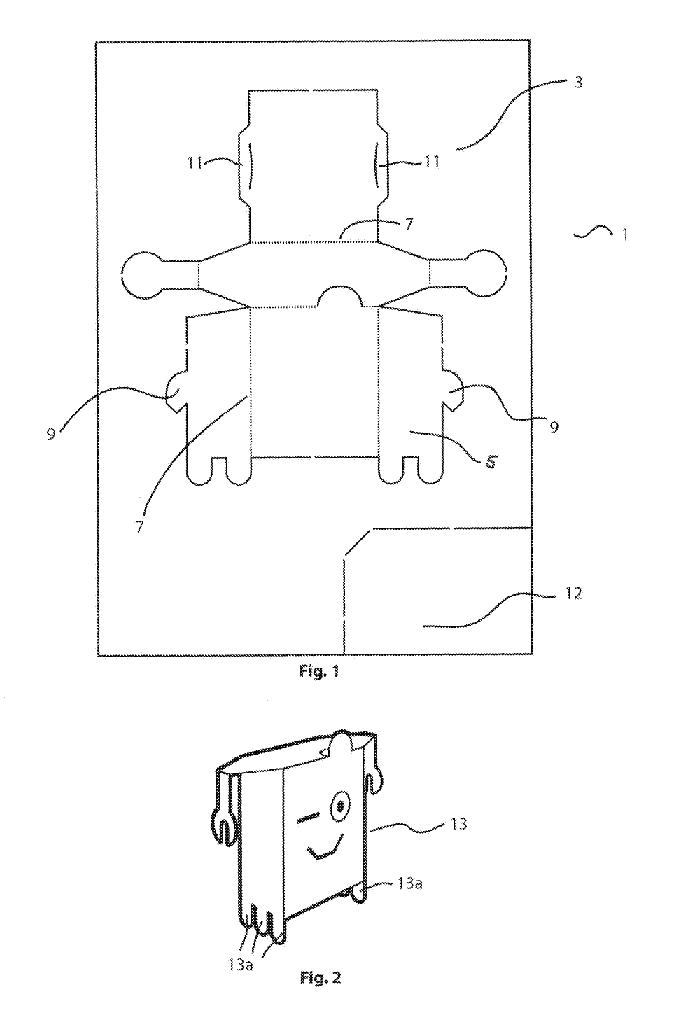

FIG. 1 is a plan view of a card constructed in accordance with the present invention;

FIG. 2 is a perspective view of the removable blank of FIG. 1, folded to form a three dimensional model in accordance with the present invention;

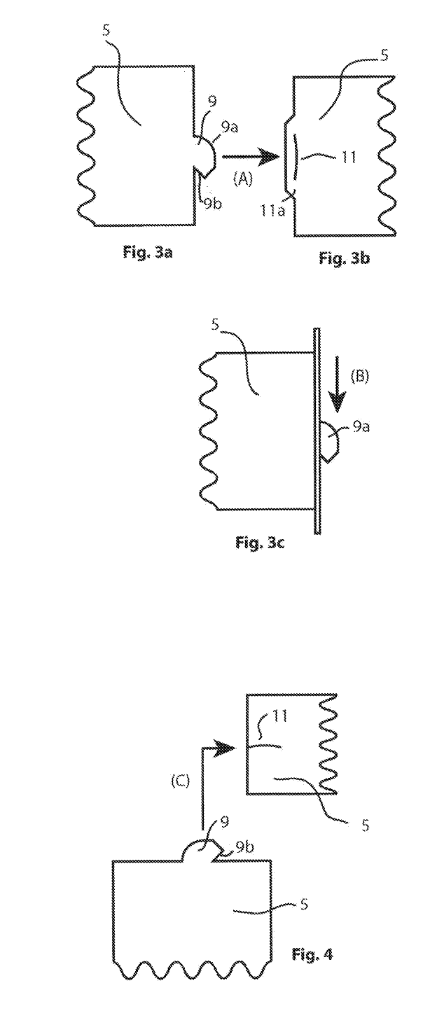

FIGS. 3a, 3b, and 3c are enlarged plan views of a first embodiment of the tab/slot arrangement configured to secure a model, such as that shown in FIG. 2; and,

FIG. 4 is an enlarged plan view of a second embodiment of the tab/slot arrangement configured to secure a model, such as that shown in FIG. 2.

For the purposes of clarity and a concise description, features are described herein as part of the same or separate embodiments; however it will be appreciated that the scope of the invention may include embodiments having combinations of all or some of the features described.

Referring to FIG. 1, the card 1 of the present invention comprises a flexible sheet 3 which frames a removable blank 5. The card is die-cut; has a height of 148.5 mm and a width of 105 mm. The card has a paper density of 280 g/m² and is made of material such as “Trucard 1”®. Although not shown in FIG. 1, both sides of the card are printed to include instructions for folding the blank 5 and features of the three-dimensional model that is to be made. The printed matter may also include information relating to collecting a series of cards 1 or for playing a game. A piece of the flexible sheet 12 on which pictures and statistics relating to the card are printed can be torn off from the card 1 along perforations around its perimeter.

The perimeter of the removable blank 5 is scored by perforations so that the blank 5 is removable from the flexible sheet 3. The blank 5 also comprises markings 7 on its upper and lower planar surfaces showing fold lines. A plurality of tabs 9 and slots 11 are spaced around the perimeter of the blank 5. The tabs 9 comprise shaped protrusions extending from the perimeter of the blank 5 and each slot 11 comprises a narrow opening through which a tab 9 can pass.

Referring to FIGS. 3a, 3b and 3c, each tab 9 comprises a shaped protrusion, which protrudes 5 mm from the perimeter of the blank 5. The tab 9 has a length of around 10 mm. The tab 9 has a curved surface 9a, configured to ensure that the tab 9 easily slides into a slot 11. The lower face of the tab 9, comprises a straight side 9b angled at 45 degrees to the perimeter of the blank 5. The angle of the straight side 9b is configured to grip the tab 9 in position after the tab 9 is slid through a slot 11.

As shown in FIG. 3b, the slot 11 is an opening of width 0.6 mm and is curved with an approximate length of 11 mm. The slot 11 is positioned in a trapezoidal protrusion 11a, which has parallel sides of length 20 mm and 14 mm and lateral sides of length 4.2 mm. The length of the slot 11 is approximately parallel to the parallel sides of the protrusion 11a and to the perimeter of the blank 5. The slot 11 runs only part-way along the length of the protrusion 11a. As shown in FIG. 3c, in use, the tab 9 is slid through the front face of the slot 11 in a direction (A) substantially perpendicular to the length of the slot. When the tab 9 is inserted to pass through the slot 11, the tab is slid downwardly in a direction (B) substantially parallel to the length of the slot 11 to lock the tab 9 through the slot 11. The acute angle between the straight side 9b of the tab 9 and the perimeter of the blank 5 grips the slot 11 and holds the tab 9 in place.

Referring to FIG. 2, in use, the blank 5 is removed from the flexible sheet 3 by applying gentle pressure to the blank and breaking the perforations around the perimeter of the blank 5. A user pushes the blank 5 through the frame of the flexible sheet 3 so that the blank 5 “pops-out” of the card 1. A user follows the instructions given on the flexible sheet 3 to fold the blank 5 along the marked fold lines 7 and to insert and lock the plurality of tabs 9 to their respective slots 11. A key system of symbols is used to indicate which tab 9 is to be fed through which slot 11, whereby a corresponding symbol is used on a tab 9 and the slot 11 into which it is to be inserted. When the folding of the blank 5 is complete and the required slots 11 and tabs 9 are locked together, the blank forms a three-dimensional model 13. The three-dimensional model 13 is self-standing. For example, the model 13 has legs 13a protruding from the base of the model 13, which rest perpendicularly to a supporting surface. Alternatively, the legs have feet that fold back perpendicular to the legs so that the feet rest flat on a supporting surface. In the embodiment shown in FIG. 2, the model has a height of 42 mm, a width of 31 mm and a depth of 15 mm.

Referring to FIG. 4, in an alternative embodiment of the tab/slot arrangement the slot 11′ comprises an “open slot” which extends to meet the edge of the blank 5. The slot 11′ is slightly curved and has a width of 0.5 mm and a length of 8.2 mm. In use, the tab 9′ is slid through the slot 11′ in a direction (C) along the length of the slot 11′. The acute angle between the straight side 9b′ of the tab 9′ and the perimeter of the blank 5 grips the slot 11′ and holds the tab 9′ in place.

Referring to FIG. 2, when the three-dimensional model 13 is formed it is held in place by the arrangement of tabs and slots to be moved and played with. There are many different shapes and configurations of models supported by cards in the manner described. For example, each model is a robot of different shape and configuration. In a series of collectible cards the robots will have different features and values.

It is envisaged that after the three-dimensional model 13 has been formed it is possible to “un-lock” the tabs 9, 9′ from the slots 11, 11′ through which they are held. The foldable blank 5 can then be unfolded and flattened. In some embodiments, the foldable blank 5 can also be pressed back into and contained by the frame of the flexible sheet 3. For example, the blank is held in place within the frame of the flexible sheet by a clear film of adhesive-backed plastic.

In alternative embodiment of the present invention, the three-dimensional model is hollow and a remote-controlled movement mechanism can be inserted into the model to enable the model to move. For example, a small electric motor is used. In further embodiments the model also houses a sound or light source, for example, a light emitting diode (LED).

In some embodiments of the present invention, the flexible sheet 3 and/or blank 5 comprises recognition elements (not shown) for activating application software, for example in the form of augmented reality.

In some embodiments of the present invention, the flexible sheet 3 and/or blank 5 comprises recognition elements (not shown) for activating augmented reality software.

The above described embodiment has been given by way of example only, and the skilled reader will naturally appreciate that many variations could be made thereto without departing from the scope of the claims.

1. A flexible sheet comprising at least one removable blank wherein the blank is configured to be foldable into a three-dimensional model, wherein the removable blank comprises at least one tab and at least one slot, wherein the tab is slideable through the slot to be secured therethrough.

2. A flexible sheet according to claim 1 comprising an acute angle between the or each tab and the blank for providing a notch to lock in position after the tab has been fed through a slot.

3. A flexible sheet according to claim 1 or 2, wherein the or each slot is curved.

4. A flexible sheet according to any preceding claim wherein the or each tab comprises at least one curved surface.

5. A flexible sheet according to any preceding claim wherein the or each tab comprises at least one straight side at an angle of about forty-five degrees to the perimeter of the blank.

6. A flexible sheet according to any preceding claim wherein the or each tab comprises a curved side and a straight side wherein the straight side is at an angle of about forty-five degrees to the perimeter of the blank.

7. A flexible sheet according to any preceding claim wherein the length of the tab is between about 8 and 12 mm.

8. A flexible sheet according to any preceding claim wherein the length of the slot is between about 8 and 13 mm.

9. A flexible sheet according to any preceding claim wherein the slot is about 1 mm longer than the length of the tab.

10. A flexible sheet according to any preceding claim wherein the removable blank is a single-piece.

11. A flexible sheet according to any preceding claim wherein the or each removable blank comprises a plurality of fold lines.

12. A flexible sheet according to claim 11 wherein the fold lines comprise lines of perforations in the removable blank.

13. A flexible sheet according to claim 11 or claim 12 wherein the plurality of fold lines are marked onto the surface of the blank.

14. A flexible sheet according to any preceding claim wherein the flexible sheet is substantially rectangular.

15. A flexible sheet according to claim 14 having a width of about 105 mm and a height of about 148.5 mm.

16. A flexible sheet according to any preceding claim wherein the paper density of the flexible sheet is about 200 to 400 g/m², preferably about 200 to 300 g/m².

17. A flexible sheet according to claim 16 wherein the paper density of the flexible sheet is about 280 g/m²

18. A flexible sheet according to any preceding claim comprising printed matter on at least one surface.

19. A flexible sheet according to claim 18 wherein the flexible sheet comprises printed matter on both planar surfaces.

20. A flexible sheet according to any preceding claim comprising a laminate material or a foil material.

21. A flexible sheet according to any of claims 18 to 20 wherein the flexible sheet is pre-printed by lithographic or digital printing.

22. A flexible sheet according to any preceding claim wherein the removable blank is configured to be foldable into a self-standing three-dimensional model.

23. A flexible sheet according to any preceding claim wherein the flexible sheet and/or blank comprises recognition elements for activating application software.

24. A flexible sheet according to any preceding claim, wherein the flexible sheet and/or blank comprises recognition elements for augmented reality software.

25. Application software for use with a flexible sheet and/or blank as described herein.

26. Augmented reality software for use with a flexible sheet and/or blank as described herein.

27. A flexible sheet substantially as hereinbefore described or referred to in FIGS. 1 to 4.
